(19) United States
(12) Patent Application Publication
(10) Pub. No.: US 2003/0192056 A1
(43) Pub. Date: Oct. 9, 2003

(54) Method of setting menu of TV receiver

(76) Inventor: Jeong Pil Yun, Seoul (KR)

Correspondence Address: BIRCH STEWART KOLASCH & BIRCH, PO BOX 747, FALLS CHURCH, VA, 22040-0747, US

(21) Appl. No.: 10/406,227

(22) Filed: Apr. 4, 2003

(30) Foreign Application Priority Data
Apr. 4, 2002 (KR) 2002-0018583

(51) Int. Cl. G06F 3/00; H04N 5/445; G06F 13/00; H04N 7/20; H04N 7/173

(52) U.S. Cl. 725/109; 725/53; 725/51; 725/63

(57) ABSTRACT

Disclosed is a method of setting a menu of a TV receiver through a remote control. The present invention carries out a remote control of menu selections such as a PPV reservation, a remind list and the like, which can be selected within a specific satellite receiver using a specific number of the TV receiver or another specific number of a smart card on Internet, thereby enabling to search the detailed APG (advanced program guide) more conveniently as well as the user's information immediately.

This application claims the benefit of the Korean Application No. P2002-18583 filed on Apr., 04, 2002, which is hereby incorporated by reference.

### BACKGROUND OF THE INVENTION

1. Field of the Invention

The present invention relates to a method of setting a menu of a TV receiver.

2. Discussion of the Related Art

Recently, as the number of channels of satellite broadcasting increases and programs are diversified, many attentions are paid to a TV receiver receiving satellite broadcasting.

Specifically, a user can be provided with such functions as PPV (pay per view), remind list, and the like on an APG (advanced program guide) menu of a TV receiver.

Moreover, the user can be provided with a great deal of APG information by the TV receiver.

Each of TV receivers has a specific number, and there is a smart card having another specific number matching with the corresponding specific number of the TV receiver.

If the identification number of the TV receiver is different from tat of the smart card, the user is unable to receive information of APG and the like and cannot watch the TV. Hence, the user is unable to make use of the above-mentioned functions.

Generally, the user enables to control and use the PPV, remind list, and the like in a menu of the TV receiver only as well as view the information about APG.

Moreover, in order to change the grade of the smart card or be informed of viewer information such as a PPV charge and the like, the user is provided with that kind of function or information through a telephone only.

Namely, the previous TV receiver provides the user with various kind of information such as APG and the like through the TV receiver of its own.

FIG. 1 illustrates a diagram of a general method of setting a menu of a general TV receiver.

Referring to FIG. 1, a user directly manipulates a menu of a TV receiver, thereby enabling to search user-demanding information and programs. The user enables to make a reservation, selection, cancellation, and the like for the searched program, and enables to store the searched program in a remind list and the like.

### SUMMARY OF THE INVENTION

Accordingly, the present invention is directed to a method of setting a menu of a TV receiver that substantially obviates one or more problems due to limitations and disadvantages of the related art.

An object of the present invention is to provide a method of setting a menu of a TV receiver enabling to setting the menu of the TV receiver through a wired/wireless communication medium.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method of setting a menu of a TV receiver transmitting/receiving information to/from a TV broadcasting system according to the present invention includes the steps of having a user account granted from the TV broadcasting system through a wired/wireless communication medium wherein the user account corresponds to an information of the TV receiver, connecting with the TV broadcasting system through the wired/wireless communication medium, and setting the menu of the TV receiver by requesting a menu setting of the corresponding TV receiver to the TV broadcasting system.

Preferably, the wired/wireless communication medium is a computer or mobile phone.

Preferably, the information of the TV receiver includes at least one of a specific number of the TV receiver and a specific number of a smart card built in the TV receiver.

Preferably, the user account of the TV broadcasting system is stored in a database of an Internet repeater or a TV broadcasting station.

Preferably, the wired/wireless communication medium logs in a homepage of a corresponding broadcasting station to connect with the TV broadcasting system.

Preferably, the step of setting the menu of the TV receiver includes the steps of receiving a request for the menu setting of the TV receiver from the wired/wireless communication medium, searching the information of the corresponding TV receiver, transmitting data for the requested menu setting to the corresponding TV receiver, and setting the menu of the TV receiver according to the transmitted data.

More preferably, the information of the TV receiver includes at least one of a specific number of the TV receiver and a specific number of a smart card built in the TV receiver.

More preferably, the information of the TV receiver is searched from a database of an Internet repeater or a TV broadcasting station.

More preferably, the data for the requested menu setting are transmitted together with a broadcasting signal of the TV broadcasting system.

In another aspect of the present invention, a method of setting a menu of a TV receiver transmitting/receiving information to/from a TV broadcasting system includes the steps of having a user account granted from the TV broadcasting system through a wired/wireless communication medium wherein the user account corresponds to an information of the TV receiver, connecting with the TV broadcasting system through the wired/wireless communication medium by logging in a homepage of a corresponding broadcasting station, transmitting a request for a menu setting of the TV receiver to the TV broadcasting system through the wired/wireless communication medium, searching an information of the corresponding TV receiver and transmitting data for the requested menu setting to the corresponding TV receiver, and setting the menu of the TV receiver according to the transmitted data.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a block diagram of a general method of setting a menu of a general TV receiver;

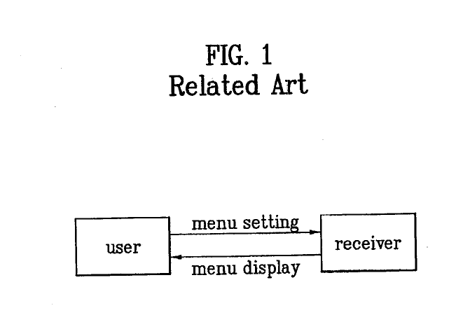

FIG. 2 illustrates a block diagram of a method of setting a menu of a TV receiver according to the present invention; and

FIG. 3 illustrates a block diagram of providing a mailing service using a method of setting a menu of a TV receiver according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

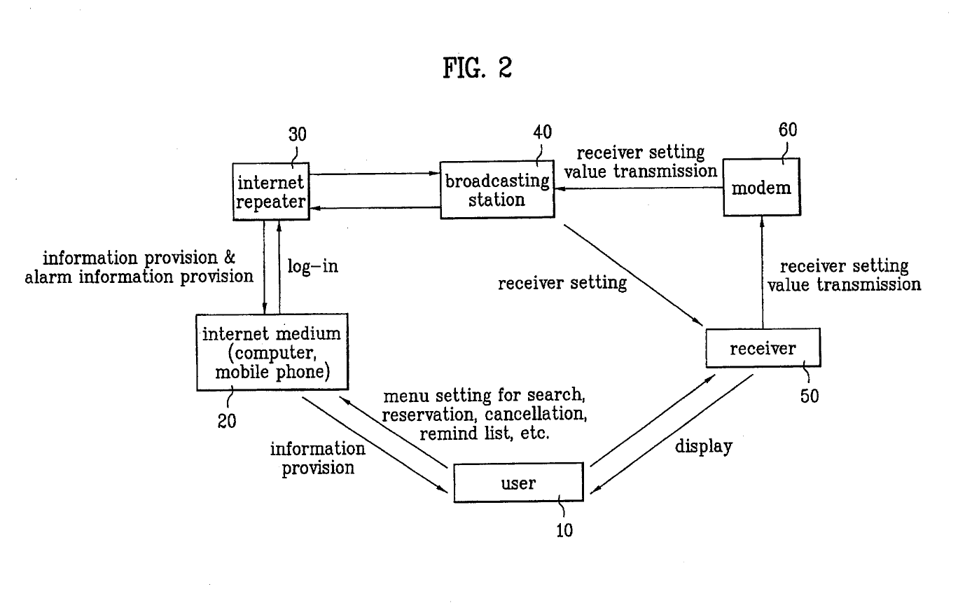

FIG. 2 illustrates a block diagram of a method of setting a menu of a TV receiver according to the present invention.

Referring to FIG. 2, a wired/wireless communication medium 20 such as a computer, mobile phone, or the like is connected to an Internet medium of a broadcasting station 40 through an Internet repeater 30.

First of all, a user 10 connects with Internet through the wired/wireless communication medium such as the computer, mobile phone, or the like, and a user account corresponding to information of a TV receiver 50 is granted on Internet to the user 10.

In this case, the information of the TV receiver 50 includes a specific number of the TV receiver 50, another specific number of a smart card built in the TV receiver, and the like.

And, the user account can be stored in a database of the Internet repeater 30 or a database of the TV broadcasting station 40.

Namely, the TV receiver 50 of the user 10 and the smart card built in the TV receiver 50 or set-top box have the specific numbers, respectively, and enable to transmit/receive data bidirectionally.

Thus, the user 10 connects with Internet using the wired/wireless communication medium, and is provided with the account, which corresponding to the specific number of the user's TV receiver 50 or the smart card, on Internet.

Then, the user 10 logs in a homepage of the broadcasting station 40 using the account, thereby enabling to search information including APG (advanced program guide) as well as carry out a function of setting a menu of the TV receiver 50 and other functions.

Namely, if the menu of the TV receiver has to be set, the user 10 sends a request for a menu setting to the broadcasting station 40 through Internet.

Thereafter, the broadcasting station 40 receives data for the menu setting of the user 10 through an Internet channel, and searches information of the TV receiver such as the specific number of the TV receiver corresponding to the user account or the specific number of the smart card and the like.

In this case, the information of the TV receiver can be searched from the database of an Internet repeater or another database of the TV broadcasting station.

The user enables to send the information of the TV receiver directly to the broadcasting station through Internet.

The broadcasting station 40 then receives the information of the TV receiver and transmits data for the menu setting to the corresponding TV receiver.

In this case, the data for the menu setting are transmitted to the TV receiver 50 of the user together with a stream signal as a broadcast signal.

Subsequently, the TV receiver 50 receives the stream signal together with the data for the menu setting to set the menu of the TV receiver according to the data.

The data for the menu setting are stored in a memory of the TV receiver, or can be displayed on a screen.

Thus, the user enables to set the menu of the TV receiver on Internet using the wired/wireless communication medium as well as enables to carry out the menu setting in the TV receiver itself.

Therefore, the user enables to control the TV receiver remotely regardless of locations.

Moreover, it is able to control other TV receivers of different users as well as the user's TV receiver. And, it is also able to search information of other TV receivers of the different users.

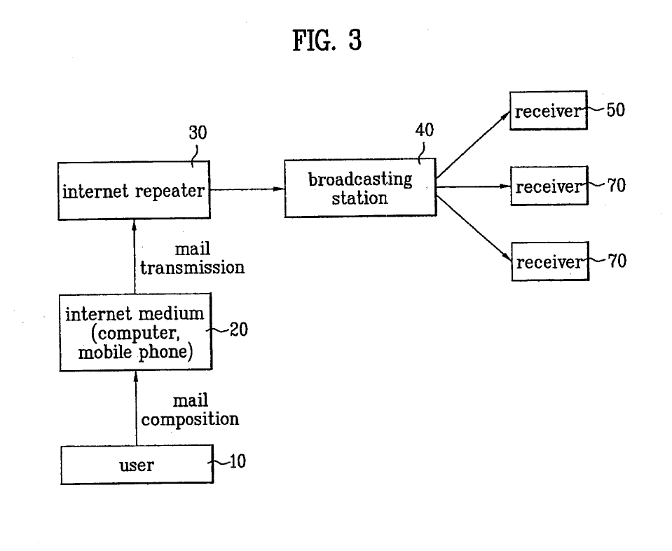

FIG. 3 illustrates a block diagram of providing a mailing service using a method of setting a menu of a TV receiver according to the present invention.

Referring to FIG. 3, the user 10 enables to send a mail to his TV receiver 50 or another TV receivers 50 of the different users using Internet.

Moreover, the user 10 selects ‘enable/disable’ of a remote control from the menu to make use of a remote control function of the TV receiver.

Namely, the user selects the remote control function in the menu of the TV receiver 50 to set the menu of the TV receiver 50 on Internet, and enables to carry out such functions as a subscriber information change, an APG information change, a mail reception/transmission, an alarming, etc.

Or, the user 10 enables to set the menu of the TV receiver directly through a modem 60.

Accordingly, the above-described method of setting the menu of the TV receiver according to the present invention has the following effects or advantages.

First of all, breaking from the limitative locality for the menu setting and information retrieval within the TV receiver 50 only, the present invention enables to accomplish the menu setting and the information retrieval of the TV receiver through the wired/wireless medium regardless of locations.

Secondly, the present invention can reserve, select, and cancel the demanded program, and enables to store the program in the remind list to make use of the program conveniently.

Thirdly, the present invention enables the user to be instantly informed of the information of the user (viewer) such as a PPV charge and the like and the various setting information set in the TV receiver 50 on Internet.

Fourthly, the present invention enables to cancel the program immediately when the user is unable to view the program as well as change the grade of the smart card.

Fifthly, once a program group is selected on Internet, the present invention can be previously provided with the information, broadcast time, and the like about the program corresponding to the group through the Internet medium such as a mail, mobile phone, and the like. And, when there exists a reserved program, the present invention caries out the function of the information provision of informing the user of the reserved program through the mail or mobile phone before the broadcast as well as the alarming information provision.

Finally, the present invention enables to switch a unidirectional mailing function to a bidirectional mailing function.

Namely, the user can be provided with the bidirectional mailing function enabling to send a mail to the TV receiver 70 of other user instead of the unidirectional mailing function that the current broadcasting station 40 sends a mail within the limits.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A method of setting a menu of a TV receiver, the TV receiver transmitting/receiving information to/from a TV broadcasting system, the method comprising the steps of:
having a user account granted from the TV broadcasting system through a wired/wireless communication medium, wherein the user account corresponds to an information of the TV receiver;
connecting with the TV broadcasting system through the wired/wireless communication medium; and
setting the menu of the TV receiver by requesting a menu setting of the corresponding TV receiver to the TV broadcasting system.

2. The method of claim 1, wherein the wired/wireless communication medium is a computer or mobile phone.

3. The method of claim 1, wherein the information of the TV receiver includes at least one of a specific number of the TV receiver and a specific number of a smart card built in the TV receiver.

4. The method of claim 1, wherein the user account of the TV broadcasting system is stored in a database of an Internet repeater or a TV broadcasting station.

5. The method of claim 1, wherein the wired/wireless communication medium logs in a homepage of a corresponding broadcasting station to connect with the TV broadcasting system.

6. The method of claim 1, the step of setting the menu of the TV receiver comprising the steps of:
receiving a request for the menu setting of the TV receiver from the wired/wireless communication medium;
searching the information of the corresponding TV receiver;
transmitting data for the requested menu setting to the corresponding TV receiver; and
setting the menu of the TV receiver according to the transmitted data.

7. The method of claim 6, wherein the information of the TV receiver includes at least one of a specific number of the TV receiver and a specific number of a smart card built in the TV receiver.

8. The method of claim 6, wherein the information of the TV receiver is searched from a database of an Internet repeater or a TV broadcasting station.

9. The method of claim 6, wherein the data for the requested menu setting are transmitted together with a broadcasting signal of the TV broadcasting system.

10. A method of setting a menu of a TV receiver, the TV receiver transmitting/receiving information to/from a TV broadcasting system, the method comprising the steps of:
having a user account granted from the TV broadcasting system through a wired/wireless communication medium wherein the user account corresponds to an information of the TV receiver;
connecting with the TV broadcasting system through the wired/wireless communication medium by logging in a homepage of a corresponding broadcasting station;
transmitting a request for a menu setting of the TV receiver to the TV broadcasting system through the wired/wireless communication medium;
searching an information of the corresponding TV receiver and transmitting data for the requested menu setting to the corresponding TV receiver; and
setting the menu of the TV receiver according to the transmitted data.

11. The method of claim 10, wherein the wired/wireless communication medium is a computer or mobile phone.

12. The method of claim 10, wherein the information of the TV receiver includes at least one of a specific number of the TV receiver and a specific number of a smart card built in the TV receiver.

13. The method of claim 10, wherein the user account of the TV broadcasting system is stored in a database of an Internet repeater or a TV broadcasting station.

14. The method of claim 10, wherein the information of the TV receiver is searched from a database of an Internet repeater or a TV broadcasting station.

15. The method of claim 10, wherein the data for the requested menu setting are transmitted together with a broadcasting signal of the TV broadcasting system.
